(19) United States
(12) Patent Application Publication
(10) Pub. No.: US 2019/0069028 A1
(43) Pub. Date: Feb. 28, 2019

(54) EVENT REGISTRATION AND NOTIFICATION

(71) Applicant: Sharp Kabushiki Kaisha, Sakai City, Osaka (JP)

(72) Inventor: Sachin G. DESHPANDE, Camas, WA (US)

(21) Appl. No.: 16/071,496

(22) PCT Filed: Feb. 2, 2017
(86) PCT No.: PCT/JP2017/003860

§ 371 Date: Jul. 20, 2018

Related U.S. Application Data
(60) Provisional application No. 62/291,500, filed on Feb. 4, 2016.

(51) Int. Cl. H04N 21/462; H04N 21/258

(52) U.S. Cl. CPC H04N 21/462; H04N 21/47214; H04N 21/25808

(57) ABSTRACT

A system for generating, transmitting, providing and/or receiving event registration and notification.

### TECHNICAL FIELD

The present invention relates generally to event registration, notification and signaling.

### BACKGROUND OF THE INVENTION

### Background Art

A broadcast service is capable of being received by all users having broadcast receivers. Broadcast services can be roughly divided into two categories, namely, a radio broadcast service carrying only audio and a multimedia broadcast service carrying audio, video and data. Such broadcast services have developed from analog services to digital services. More recently, various types of broadcasting systems (such as a cable broadcasting system, a satellite broadcasting system, an Internet based broadcasting system, and a hybrid broadcasting system using both a cable network, Internet, and/or a satellite) provide high quality audio and video broadcast services along with a high-speed data service. Also, broadcast services include sending and/or receiving audio, video, and/or data directed to an individual computer and/or group of computers and/or one or more mobile communication devices.

In addition to more traditional stationary receiving devices, mobile communication devices are likewise configured to support such services. Such configured mobile devices have facilitated users to use such services while on the move, such as mobile phones. An increasing need for multimedia services has resulted in various wireless/broadcast services for both mobile communications and general wire communications. Further, this convergence has merged the environment for different wire and wireless broadcast services.

Advanced Television Systems Committee (ATSC) include a set of standards developed by the Advanced Television Systems Committee for digital television transmission over terrestrial, cable, and satellite networks. ATSC 2.0 allows interactive and hybrid television technologies by connecting the TV with Internet services and allowing interactive elements into the broadcast stream. ATSC 2.0 also allows for advanced video compression, audience measurement, targeted advertising, enhanced programming guides, video on demand services, and the ability to store information on receivers, including non real-time (NRT) content. ATSC 3.0 provides additional services to the viewer and increased bandwidth efficiency and compression per-formance. ATSC3.0 support hybrid services where part of the service may be delivered via broadcast and part of the service may be delivered via broadband. One of the aspects of ATSC 3.0 includes a technique for the registration of events to be received by the receiver and/or by applications on the receiver and a technique for the notification of such events to the receiver and/or to applications on the receiver. Additionally receiver may generate events and applications on the receiver may register to receive the events. In that case the receiver may notify such events to the applications. An ineffective technique for such registration and notification can result in excess flooding of unnecessary messages to an application from the receiver.

The foregoing and other objectives, features, and advantages of the invention will be more readily understood upon consideration of the following detailed description of the invention, taken in conjunction with the accompanying drawings.

### BRIEF DESCRIPTION OF DRAWINGS

FIG. 1 illustrates a block diagram illustrating an exemplary system that includes one or more service providers and one or more receiver devices.

FIG. 2 illustrates a block diagram illustrating an example of a receiver device that may implement one or more techniques of this disclosure.

FIG. 3 illustrates a block diagram illustrating an example of another receiver device that may implement one or more techniques of this disclosure.

FIG. 4 illustrates an exemplary emsg box.

FIG. 5 illustrates an exemplary AEI (application event information) syntax.

FIG. 6 illustrates an exemplary evti box.

FIG. 7 illustrates an exemplary inband_event_descriptor( )syntax.

FIG. 8 illustrates an exemplary eventType table.

### DESCRIPTION OF EMBODIMENTS

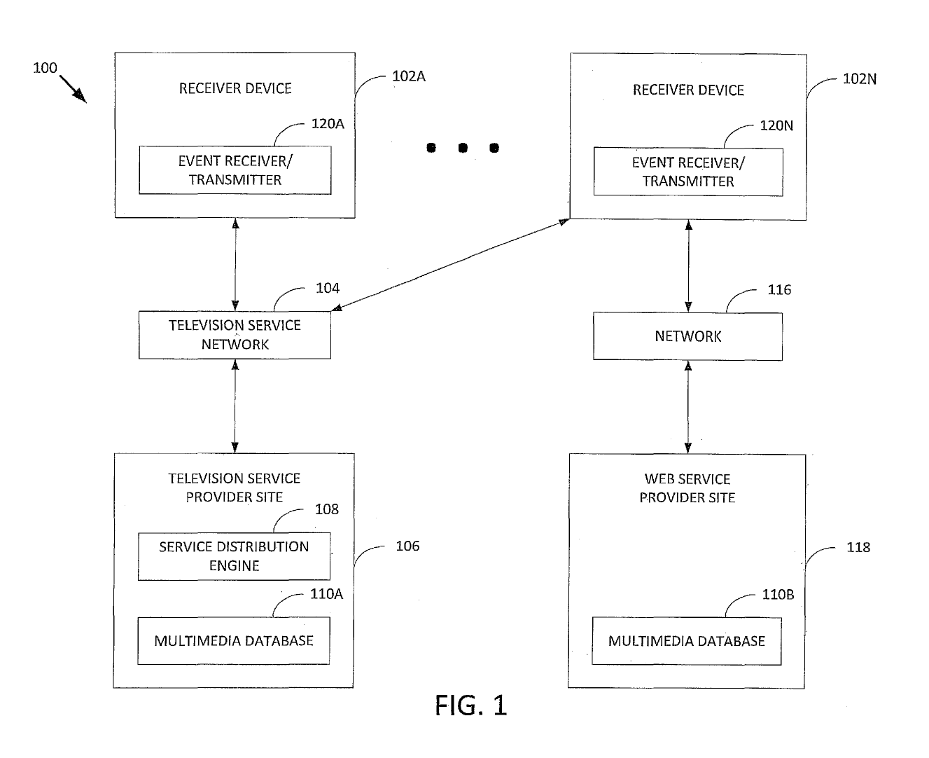

FIG. 1 is a block diagram illustrating an example of a system that may implement one or more techniques described herein. The system 100 may be configured to provide content information to a receiver device in accordance with the techniques described herein. In the example illustrated in FIG. 1, the system 100 includes one or more receiver devices 102A-102N, a television service network 104, a television service provider site 106, a network 116, and a web service provider site 118. The system 100 may include software modules. Software modules may be stored in a memory and executed by a processor. The system 100 may include one or more processors and a plurality of internal and/or external memory devices. Examples of memory devices include file servers, FTP servers, network attached storage (NAS) devices, local disk drives, or any other type of device or storage medium capable of storing data. Storage media may include Blu-ray discs, DVDs, CD-ROMs, magnetic disks, flash memory, or any other suitable digital storage media. When the techniques described herein are implemented partially in software, a device may store instructions for the software in a suitable, non-transitory computer-readable medium and execute the instructions in hardware using one or more processors.

The system 100 represents an example of a system that may be configured to allow digital media content, such as, for example, television programming, to be distributed to and accessed by a plurality of computing devices, such as the receiver devices 102A-102N. In the example illustrated in FIG. 1, the receiver devices 102A-102N may include any device configured to receive a transport stream from the television service provider site 106. For example, the receiver devices 102A-102N may be equipped for wired and/or wireless communications and may include televisions, including so-called smart televisions, set top boxes, and digital video recorders. Further, the receiver devices 102A-102N may include desktop, laptop, or tablet computers, gaming consoles, mobile devices, including, for example, “smart” phones, cellular telephones, and personal gaming devices configured to receive a transport stream from the television provider site 106. It should be noted that although example the system 100 is illustrated as having distinct sites, such an illustration is for descriptive purposes and does not limit the system 100 to a particular physical architecture. Functions of system 100 and sites included therein may be realized using any combination of hardware, firmware, and/or software implementations.

The television service network 104 is an example of a network configured to enable television services to be provided. For example, the television service network 104 may include public over-the-air television networks, public or subscription-based satellite television service provider networks, and public or subscription-based cable television provider networks and/or over the top or Internet service providers. It should be noted that although in some examples the television service network 104 may primarily be used to enable television services to be provided, the television service network 104 may also enable other types of data and services to be provided according to any combination of the telecommunication protocols described herein. The television service network 104 may comprise any combination of wireless and/or wired communication media. The television service network 104 may include coaxial cables, fiber optic cables, twisted pair cables, wireless transmitters and receivers, routers, switches, repeaters, base stations, or any other equipment that may be useful to facilitate communications between various devices and sites. The television service network 104 may operate according to a combination of one or more telecommunication protocols. Telecommunications protocols may include proprietary aspects and/or may include standardized telecommunication protocols. Examples of standardized telecommunications protocols include DVB (Digital Video Broadcasting) standards, ATSC standards, ISDB (Integrated Services Digital Broadcasting) standards, DTMB (Digital Terrestrial Multimedia Broadcast) standards, DMB (Digital Multimedia Broadcasting) standards, Data Over Cable Service Interface Specification (DOCSIS) standards, Hybrid Broadcast and Broadband (HbbTV) standard, W3C standards, and Universal Plug and Play (UPnP) standards.

Referring again to FIG. 1, the television service provider site 106 may be configured to distribute television service via the television service network 104. For example, the television service provider site 106 may include a public broadcast station, a cable television provider, or a satellite television provider. In some examples, the television service provider site 106 may include a broadcast service provider or broadcaster. In the example illustrated in FIG. 1, the television service provider site 106 includes a service distribution engine 108 and a multimedia database 110A. The service distribution engine 108 may be configured to receive a plurality of program feeds and distribute the feeds to the receiver devices 102A-102N through the television service network 104. For example, the service distribution engine 108 may include a broadcast station configured to transmit television broadcasts according to one or more of the transmission standards described above (e.g., an ATSC standard). The multimedia database 110A may include storage devices configured to store multimedia content and/or content information, including content information associated with program feeds. In some examples, the television service provider site 106 may be configured to access stored multimedia content and distribute multimedia content to one or more of the receiver devices 102A-102N through the television service network 104. For example, multimedia content (e.g., music, movies, and TV shows) stored in the multimedia database 110A may be provided to a user via the television service network 104 on an on demand basis.

The network 116 may comprise any combination of wireless and/or wired communication media. The network 116 may include coaxial cables, fiber optic cables, twisted pair cables, Ethernet cables, wireless transmitters and receivers, routers, switches, repeaters, base stations, or any other equipment that may be useful to facilitate communications between various devices and sites. The network 116 may be distinguished based on levels of access. For example, the network 116 may enable access to the World Wide Web. Or the network 116 may enable a user to access a subset of devices, e.g., computing devices located within a user's home. Thus the network may be wide area network or local area network or a combination of it and may also be generally referred to as Internet or broadband network. In some instances, local area network may be referred to as a personal network or a home network.

The network 116 may be packet based networks and operate according to a combination of one or more telecommunication protocols. Telecommunications protocols may include proprietary aspects and/or may include standardized telecommunication protocols. Examples of standardized telecommunications protocols include Global System Mobile Communications (GSM) standards, code division multiple access (CDMA) standards, 3rd Generation Partnership Project (3GPP) standards, European Telecommunications Standards Institute (ETSI) standards, Internet Protocol (IP) standards, Wireless Application Protocol (WAP) standards, and IEEE standards, such as, for example, one or more of the IEEE 802 standards (e.g., Wi-Fi).

Referring again to FIG. 1, the web service provider site 118 may be configured to provide hypertext based content or applications or other metadata associated with applications or audio/video/closed caption/media content, and the like, to one or more of the receiver devices 102A-102N through the network 116. The web service provider site 118 may include one or more web servers. Hypertext content may be defined according to programming languages, such as, for example, Hypertext Markup Language (HTML), Dynamic HTML, Extensible Markup Language (XML), and data formats such as JavaScript Object Notation (JSON). JavaScript Object Notation (JSON) is a data interchange format.

JSON schema defines a JSON based format for defining the structure of JSON data. JSON schema is intended to define validation, documentation, hyperlink navigation, and interaction control of JSON data.

An object is an unordered collection of zero or more name and value pairs, where a name is a string and a value is a string, number, Boolean, null, object, or array.

A JSON schema is a JSON document, which may be an object. Object properties defined by JSON schema are called keywords or schema keywords.

A JSON schema may contain properties which are not schema keywords.

A JSON value may be an object, array, number, string, or one of false, null, or true.

The terms property or element or key or keyword or name or parameter or element may be used interchangeably in this document. The term property may be used to refer the name of an object or element or parameter in this document.

An example of a webpage content distribution site includes the United States Patent and Trademark Office website. Further, the web service provider site 118 may be configured to provide content information, including content information associated with program feeds, to the receiver devices 102A-102N. Hypertext content and content information may be utilized for applications. It should be noted that hypertext based content and the like may include audio and video content. For example, in the example illustrated in FIG. 1, the web service provider site 118 may be configured to access a multimedia database 110B and distribute multimedia content and content information to one or more of the receiver devices 102A-102N through the network 116. In one example, the web service provider site 118 may be configured to provide multimedia content using the Internet protocol suite. For example, the web service provider site 118 may be configured to provide multimedia content to a receiver device according to Real Time Streaming Protocol (RTSP). It should be noted that the techniques described herein may be applicable in the case where a receiver device receives multimedia content and content information associated therewith from a web service provider site.

Referring to FIG. 1 the web service provider site may provide support for application and events. An application may be a collection of documents constituting a self-contained enhanced or interactive service. Documents of an application are, for example: HTML, XHTML, Java, JavaScript, CSS, XML, multimedia files, etc. An interactive application may be capable of carrying out tasks based on input from a broadcaster or viewer. An event may be communication of some information from a first entity to a second entity in an asynchronous manner. In some cases an event may be communicated from one entity to another entity without an explicit request from the first entity. An event may be a communication of some information from a first part of an entity to a second part of the same entity in an asynchronous manner. By way of example, the receiver device may communicate an event from a first part of the receiver device to a second part of the same receiver device. An event reception may (though not always) trigger an action. A receiver device may communicate an event notification to an application. The application receiving event notification may be running on the receiver or may be associated with the receiver.

Each of the receiver devices 102A-102N, may include a respective event receiver/transmitter 120A-120N, also generally referred to herein as an event transceiver. The event receiver/transmitter 120A-120N may be capable of receiving events, transmitting events, and/or both receiving and transmitting events. In this manner, the television service provider site 106 and/or the web service provider site 118 may communicate an event to the event receiver/transmitter 120A-120N. In this manner, the event receiver/transmitter 120A-120N may communicate an event to the television service provider site 106 and/or the web service provider site 118. Further, one of the event receiver/transmitter 120A-120N may communicate an event to another of the event receiver/transmitter 120A-120N. Moreover, an event receiver/transmitter of one of the receiver devices 102A-102N may communicate with another event receiver/transmitter of the same receiver devices 102A-102N. The television service provider site 106 may include a respective event/transmitter. The web service provider site 118 may include a respective event/transmitter.

A model to execute interactive adjunct data services may include, for example, a direct execution model and a triggered declarative object (TDO) model. In the direct execution model, a declarative object (DO) can be automatically launched as soon as the channel is selected by user on a receiver device 200, e.g. selecting a channel on a television. The channel may be virtual channel. A virtual channel is said to be “selected” on a receiving device when it has been selected for presentation to a viewer. This is analogous to being “tuned to” an analog TV channel. A DO can communicate over the Internet with a server to get detailed instructions for providing interactive features-creating displays in specific locations on the screen, conducting polls, launching other specialized DOs, etc., all synchronized with the audio-video program. In one embodiment the backend server may be the web service provider site 118.

In the TDO model, signals can be delivered in the broadcast stream or via the

Internet in order to initiate TDO events, such as launching a TDO, terminating a TDO, or prompting some task by a TDO. These events can be initiated at specific times, typically synchronized with the audio-video program. When a TDO is launched, it can provide the interactive features it is programmed to provide.

The term Declarative Object (DO) can consist of a collection constituting an interactive application. An application as defined previously may be a collection of documents constituting a self-contained enhanced or interactive service. Documents of an application are, for example: HTML, XHTML, Java, JavaScript, CSS, XML, multimedia files, etc. An interactive application may be capable of carrying out tasks based on input from a broadcaster or viewer.

The term “Triggered Declarative Object” (TDO) can be used to designate a

Declarative Object that has been launched by a Trigger in a Triggered interactive adjunct data service, or a DO that has been launched by a Trigger, and so on iteratively.

A basic concept behind the TDO model is that the files that make up a TDO, and the data files to be used by a TDO to take some action, all need some amount of time to be delivered to a receiver, given their size. While the user experience of the interactive elements can be authored prior to the broadcast of the content, certain behaviors may be carefully timed to coincide with events in the program itself, for example the occurrence of a commercial advertising segment.

The TDO model separates the delivery of declarative objects and associated data, scripts, text and graphics from the signaling of the specific timing of the playout of interactive events.

The element that establishes the timing of interactive events is the Trigger.

The information about the TDOs used in a segment and the associated TDO events that are initiated by Triggers is provided by a data structure called the “TDO Parameters Table” (TPT).

A TPT may contain information about TDOs of segments and the Events targeted to them. TDO information may correspond to an application identifier (appID), an application type, application name(s), application version, location of files which are part of the application, information that defines application boundary, and/or information that defines application origin. Event information within a TPT may contain an event identifier (eventID), action to be applied when the event is activated, target device type for the application, and/or a data field related to the event. A data field related to event may contain an identifier (dataID), data to be used for the event. Additionally, a TPT may also contain information about trigger location, version, required receiver capabilities, how long the information within the TPT is valid, when a receiver may need to check and download a new TPT.

Actions control an application's lifecycle. Actions may indicate to which state an application may transition.

In an example, event(s) may correspond to application lifecycle control action(s).

In an example, application lifecycle control action(s) may correspond to event(s).

An Application Information Table (AIT) may provide information on for e.g. the required activation state of applications carried by it, application type, application profile, application priority, application version, application identifier (applD) etc. Data in the AIT may allow the broadcaster to request that the receiver change the activation state of an application. Note—an AIT may contain some data elements which are functionally equivalent to some data elements in TPT.

In yet another embodiment an application may execute on a receiver 102A-102N within a browser environment. In this case an application package may be downloaded from a broadcast (e.g. 104) or broadband network (e.g. 116). Then the application is launched by opening an Uniform Resource Locator (URL) with the application package.

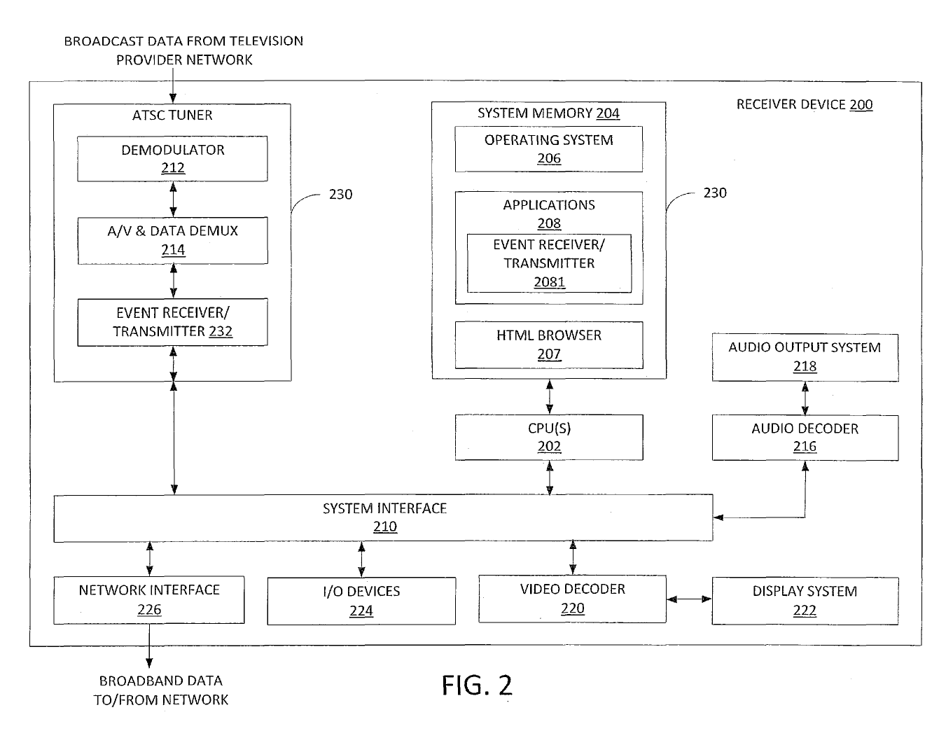

FIG. 2 is a block diagram illustrating an example of a receiver device that may implement one or more techniques of this disclosure. The receiver device 200 is an example of a computing device that may be configured to receive data from a communications network and allow a user to access multimedia content. In the example illustrated in FIG. 2, the receiver device 200 is configured to receive data via a television network, such as, for example, the television service network 104 described above. Further, in the example illustrated in FIG. 2, the receiver device 200 is configured to send and receive data via a local area network and/or a wide area network. The receiver device 200 may be configured to send data to and receive data from a receiver device via a local area network or directly. It should be noted that in other examples, the receiver device 200 may be configured to simply receive data through the television network 106 and send data to and/or receive data from (directly or indirectly) a receiver device. The techniques described herein may be utilized by devices configured to communicate using any and all combinations of communications networks.

As illustrated in FIG. 2, the receiver device 200 includes a central processing unit(s) 202, a system memory 204, a system interface 210, a demodulator 212, an A/V & data demux 214, an event receiver 232, an audio decoder 216, an audio output system 218, a video decoder 220, a display system 222, an I/O devices 224, and a network interface 226. The combination of the demodulator 212, the AV & data demux 214, and the event receiver 232, may be considered an ATSC tuner 230. As illustrated in FIG. 2, the system memory 204 includes an operating system 206, a html browser 207, and applications 208. Applications 208 may be called broadcaster applications. Applications may include a module 2081 to register or unregister for event(s) and for receiving event notifications. Some applications 208 may only register/unregister for events and receiver event notifications but may not transmit events. The html browser 207 may also be suitable to receive and/or transmit events. The html browser may receive/transmit events to event transmitter/receiver 2081 in applications 208. The operating system 206 may receive/transmit events to event transmitter/receiver 2081 in Applications 208. Each of the central processing unit(s) 202, the system memory 204, the system interface 210, the demodulator 212, the A/V & data demux 214, the audio decoder 216, the audio output system 218, the video decoder 220, the display system 222, the I/O devices 224, and the network interface 226 may be interconnected (physically, communicatively, and/or operatively) for inter-component communications and may be implemented as any of a variety of suitable circuitry, such as one or more microprocessors, digital signal processors (DSPs), application specific integrated circuits (ASICs), field programmable gate arrays (FPGAs), discrete logic, software, hardware, firmware or any combinations thereof. It should be noted that although example the receiver device 200 is illustrated as having distinct functional blocks, such an illustration is for descriptive purposes and does not limit the receiver device 200 to a particular hardware architecture. Functions of the receiver device 200 may be realized using any combination of hardware, firmware and/or software implementations.

The CPU(s) 202 may be configured to implement functionality and/or process instructions for execution in the receiver device 200. The CPU(s) 202 may be capable of retrieving and processing instructions, code, and/or data structures for implementing one or more of the techniques described herein. Instructions may be stored on a computer readable medium, such as the system memory 204 and/or storage devices. The CPU(s) 202 may include single and/or multi-core central processing units.

The system memory 204 may be described as a non-transitory or tangible computer-readable storage medium. In some examples, the system memory 204 may provide temporary and/or long-term storage. In some examples, the system memory 204 or portions thereof may be described as non-volatile memory and in other examples portions of the system memory 204 may be described as volatile memory. Examples of volatile memories include random access memories (RAM), dynamic random access memories (DRAM), and static random access memories (SRAM). Examples of non-volatile memories include magnetic hard discs, optical discs, floppy discs, flash memories, or forms of electrically programmable memories (EPROM) or electrically erasable and programmable (EEPROM) memories. The system memory 204 may be configured to store information that may be used by the receiver device 2200 during operation. The system memory 204 may be used to store program instructions for execution by the CPU(s) 202 and may be used by programs running on the receiver device 200 to temporarily store information during program execution. Further, in the example where the receiver device 200 is included as part of a digital video recorder, the system memory 204 may be configured to store numerous video files.

The applications 208 may include applications implemented within or executed by the receiver device 200 and may be implemented or contained within, operable by, executed by, and/or be operatively/communicatively coupled to components of the receiver device 200. The applications 208 may be run within the html browser 207. The applications 208 may include instructions that may cause the CPU(s) 202 of the receiver device 200 to perform particular functions. The applications 208 may include algorithms which are expressed in computer programming statements, such as, for-loops, while-loops, if-statements, do-loops, etc. The applications 208 may be developed using a specified programming language. Examples of programming languages include, Java™, Jini™, C, C++, Objective C, Swift, Perl, Python, PhP, UNIX Shell, Visual Basic, and Visual Basic Script. In the example where the receiver devices 200 includes a smart television, applications may be developed by a television manufacturer or a broadcaster. Although figures use the term applications 208—plural, there may be just a single application 208. As illustrated in FIG. 2, the applications 208 may execute in conjunction with the operating system 206. That is, the operating system 206 may be configured to facilitate the interaction of the applications 208 with the CPU(s) 202, and other hardware components of the receiver device 200. The operating system 206 may be an operating system designed to be installed on set-top boxes, digital video recorders, televisions, and the like. It should be noted that techniques described herein may be utilized by devices configured to operate using any and all combinations of software architectures. In some embodiments the operating system 206 may be a middleware 206 which provides common functionality required by applications. Also the term “run-time platform” may be used for this. In one example, the operating system 206 and/or the applications 208 and/or the html browser 207 may be configured to establish a subscription with a receiver device and generate content information messages in accordance with the techniques described in detail below.

The system interface 210 may be configured to enable communications between components of the computing device 200. In one example, the system interface 210 comprises structures that enable data to be transferred from one peer device to another peer device or to a storage medium. For example, the system interface 210 may include a chipset supporting Accelerated Graphics Port (“AGP”) based protocols, Peripheral Component Interconnect (PCI) bus based protocols, such as, for example, the PCI Express™ (“PCIe”) bus specification, which is maintained by the Peripheral Component Interconnect Special Interest Group, or any other form of structure that may be used to interconnect peer devices (e.g., proprietary bus protocols).

As described above, the receiver device 200 is configured to receive and, optionally, send data via a television service network. As described above, a television service network may operate according to a telecommunications standard. A telecommunications standard may define communication properties (e.g., protocol layers), such as, for example, physical signaling, addressing, channel access control, packet properties, and data processing. In the example illustrated in FIG. 2, the demodulator 212, the A/V & data demux 214, and/or the event receiver 232, may be configured to extract video, audio, and data from a transport stream. A transport stream may be defined according to, for example, DVB standards, ATSC standards, ISDB standards, DTMB standards, DMB standards, and DOCSIS standards. It should be noted that although the demodulator 212, the A/V & data demux 214, and the event receiver/transmitter 232 are illustrated as distinct functional blocks, the functions performed by the demodulator 212, the A/V & data demux 214 and/or the event receiver/transmitter 232, may be highly integrated and realized using any combination of hardware, firmware and/or software implementations. Further, it should be noted that for the sake of brevity a complete description of digital RF (radio frequency) communications (e.g., analog tuning details, error correction schemes, etc.) is not provided herein. The techniques described herein are generally applicable to digital RF communications techniques used for transmitting digital media content and associated content information.

In one example, the demodulator 212 may be configured to receive signals from an over-the-air signal and/or a coaxial cable and perform demodulation. Data may be modulated according a modulation scheme, for example, quadrature amplitude modulation (QAM), vestigial sideband modulation (VSB), or orthogonal frequency division modulation (OFDM). The result of demodulation may be a transport stream. A transport stream may be defined according to a telecommunications standard, including those described above. An Internet Protocol (IP) based transport stream may include a single media stream or a plurality of media streams, where a media stream includes video, audio and/or data streams. Some streams may be formatted according to ISO base media file formats (ISOBMFF). A Motion Picture Experts Group (MPEG) based transport stream may include a single program stream or a plurality of program streams, where a program stream includes video, audio and/or data elementary streams. In one example, a media stream or a program stream may correspond to a television program (e.g., a TV “channel”) or a multimedia stream (e.g., an on demand unicast). The AN & data demux 214 may be configured to receive transport streams and/or program streams and extract video packets, audio packets, and data packets. That is, the AV demux 214 may apply demultiplexing techniques to separate video elementary streams, audio elementary streams, and data elementary streams for further processing by the receiver device 200. In addition, the event receiver 232 may be configured to receive specified events and/or transmit specified events.

Referring again to FIG. 2, packets may be processed by the CPU(s) 202, the audio decoder 216, and the video decoder 220. The audio decoder 216 may be configured to receive and process audio packets. For example, the audio decoder 216 may include a combination of hardware and software configured to implement aspects of an audio codec. That is, the audio decoder 216 may be configured to receive audio packets and provide audio data to the audio output system 218 for rendering. Audio data may be coded using multi-channel formats such as those developed by Dolby and Digital Theater Systems. Audio data may be coded using an audio compression format. Examples of audio compression formats include MPEG formats, AAC formats, DTS-HD formats, and AC-3 formats. The audio system 218 may be configured to render audio data. For example, the audio system 218 may include an audio processor, a digital-to-analog converter, an amplifier, and a speaker system. A speaker system may include any of a variety of speaker systems, such as headphones, an integrated stereo speaker system, a multi-speaker system, or a surround sound system.

The video decoder 220 may be configured to receive and process video packets. For example, the video decoder 220 may include a combination of hardware and software used to implement aspects of a video codec. In one example, the video decoder 220 may be configured to decode video data encoded according to any number of video compression standards, such as ITU-T H.262 or ISO/IEC MPEG-2 Visual, ISO/IEC MPEG-4 Visual, ITU-T H.264 (also known as ISO/IEC MPEG-4 AVC), and High-Efficiency Video Coding (HEVC). The display system 222 may be configured to retrieve and process video data for display. For example, the display system 222 may receive pixel data from the video decoder 220 and output data for visual presentation. Further, the display system 222 may be configured to output graphics in conjunction with video data, e.g., graphical user interfaces. Display system may comprise one of a variety of display devices such as a liquid crystal display (LCD), a plasma display, an organic light emitting diode (OLED) display, or another type of display device capable of presenting video data to a user. A display device may be configured to display standard definition content, high definition content, or ultra-high definition content.

The I/O devices 224 may be configured to receive input and provide output during operation of the receiver device 200. That is, the I/O device 224 may enable a user to select multimedia content to be rendered. Input may be generated from an input device, such as, for example, a push-button remote control, a device including a touch-sensitive screen, a motion-based input device, an audio-based input device, or any other type of device configured to receive user input. The I/O device(s) 224 may be operatively coupled to the computing device 200 using a standardized communication protocol, such as for example, Universal Serial Bus protocol (USB), Bluetooth, ZigBee or a proprietary communications protocol, such as, for example, a proprietary infrared communications protocol.

The network interface 226 may be configured to enable the receiver device 200 to send and receive data via a local area network and/or a wide area network. Further, network interface may be configured to enable the receiver device 200 to communicate with a receiver device. The network interface 226 may include a network interface card, such as an Ethernet card, an optical transceiver, a radio frequency transceiver, or any other type of device configured to send and receive information. The network interface 226 may be configured to perform physical signaling, addressing, and channel access control according to the physical and Media Access Control (MAC) layers utilized in a network.

As described above, the A/V & data demux 214 may be configured to extract data packets from a transport stream. Data packets may include content information. In another example, the network interface 226 and in turn the system interface 210 may extract the data packets. In this example the data packets may originate from a network, such as, the network 116. As used herein, the term content information may refer generally to any information associated with services received via a network. Further, the term content information may refer more specifically to information associated with specific multimedia content. Data structures for content information may be defined according to a telecommunications standard. For example, ATSC standards describe Program and System Information Protocol (PSIP) tables which include content information. Types of PSIP tables include Event Information Tables (EIT), Extended Text Tables (ETT) and Data Event Tables (DET). In ATSC standards, DETs and EITs may provide event descriptions, start times, and durations. In ATSC standards, ETTs may include text describing virtual channels and events. Further, in a similar manner to ATSC, DVB standards include Service Description Tables, describing services in a network and providing the service provider name, and EITs including event names descriptions, start times, and durations. The receiver device 200 may be configured to use these tables to display content information to a user (e.g., present an EPG).

In addition to or as an alternative to extracting tables from a transport stream to retrieve content information, as described above, the receiver device 200 may be configured to retrieve content information using alternative techniques. For example, ATSC 2.0 defines Non-Real-Time Content (NRTC) delivery techniques. NRTC techniques may enable a receiver device to receive content information via a file delivery protocol (e.g., File Delivery over Unidirectional Transport (FLUTE) and/or via the Internet (e.g., using HTTP). Content information transmitted to a receiver device according to NRTC may be formatted according to several data formats. One example format includes the data format defined in Open Mobile Alliance (OMA) BCAST Service Guide Version 1.0.1. In a similar manner, DVB standards define Electronic Service Guide (ESG) techniques which may be used for transmitting content information. A service guide may provide information about current and future service and/or content. The receiver device 200 may be configured to receive content information according to NRTC techniques and/or ESG techniques. That is, the receiver device 200 may be configured to receive a service guide. In should be noted that the techniques described herein may be generally applicable regardless of how a receiver device receives content information. As described above, the receiver device 200 may be configured to send data to and receive data from a receiver device via a local area network or directly.

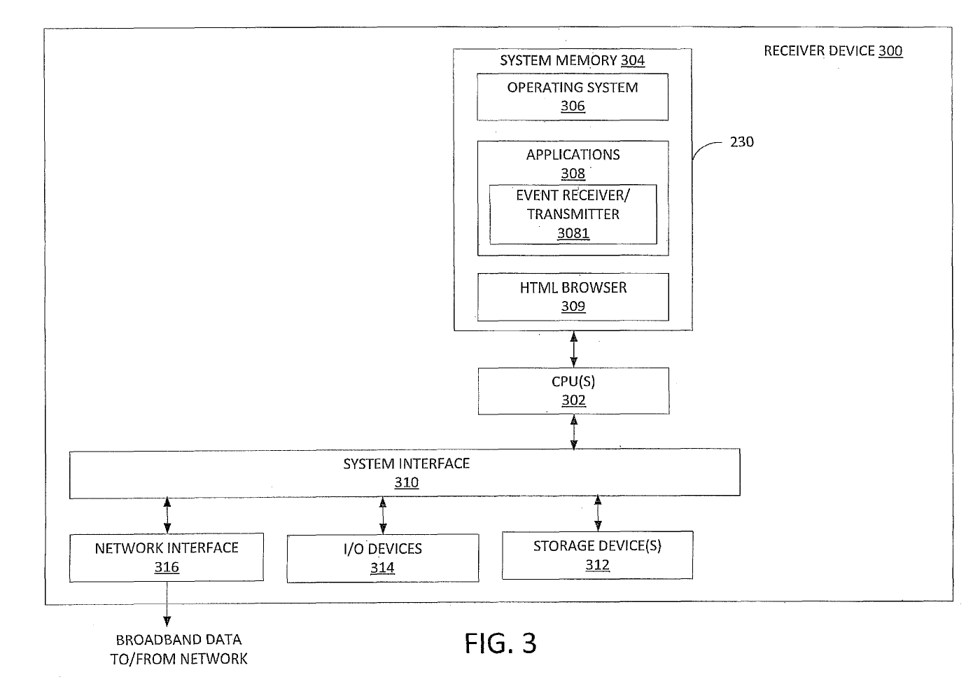

FIG. 3 is a block diagram illustrating an example of a receiver device that may implement one or more techniques of this disclosure. The receiver device 300 may include one or more processors and a plurality of internal and/or external storage devices. The receiver device 300 is an example a device configured communicate with a receiver device. For example, the receiver device 300 may be configured to receive content information from a receiver device. The receiver device 300 may include one or more applications running thereon that may utilize information included in a content information communication message. Receiver device 300 may be equipped for wired and/or wireless communications and may include devices, such as, for example, desktop or laptop computers, mobile devices, smartphones, cellular telephones, personal data assistants (PDA), tablet devices, and personal gaming devices.

As illustrated in FIG. 3, the receiver device 300 includes a central processor unit(s) 302, a system memory 304, a system interface 310, a storage device(s) 312, an I/O device(s) 314, and a network interface 316. As illustrated in FIG. 3, the system memory 304 includes an operating system 306, applications 308, and/or a HTML browser 309. Applications 308 may be called broadcaster applications. Applications may include a module 3081 to register or unregister for event(s) and for receiving event notifications. Some applications 308 may only register/unregister for events and receiver event notifications but may not transmit events. The html browser 309 may also be suitable to receive and/or transmit events. The html browser may receive/transmit events to event transmitter/receiver 3081 in applications 308. The operating system 306 may receive/transmit events to event transmitter/receiver 3081 in applications 308. It should be noted that although example the receiver device 300 is illustrated as having distinct functional blocks, such an illustration is for descriptive purposes and does not limit the receiver device 300 to a particular hardware or software architecture. Functions of the receiver device 300 may be realized using any combination of hardware, firmware and/or software implementations. One of the difference between receiver of FIG. 2 and FIG. 3 is that the FIG. 3 receiver may primarily get all its data from the broadband network.

Each of the central processor unit(s) 302, the system memory 304, and the system interface 310, may be similar to the central processor unit(s) 202, the system memory 204, and the system interface 210 described above. The storage device(s) 312 represent memory of the receiver device 300 that may be configured to store larger amounts of data than system memory 304. For example, the storage device(s) 312 may be configured to store a user's multimedia collection. Similar to the system memory 304, the storage device(s) 312 may also include one or more non-transitory or tangible computer-readable storage media. The storage device(s) 312 may be internal or external memory and in some examples may include non-volatile storage elements. The storage device(s) 312 may include memory cards (e.g., a Secure Digital (SD) memory card, including Standard-Capacity (SDSC), High-Capacity (SDHC), and eXtended-Capacity (SDXC) formats), external hard disk drives, and/or an external solid state drive.

The I/O device(s) 314 may be configured to receive input and provide output for receiver device 300. Input may be generated from an input device, such as, for example, touch-sensitive screen, track pad, track point, mouse, a keyboard, a microphone, video camera, or any other type of device configured to receive input. Output may be provided to output devices, such as, for example, speakers or a display device. In some examples, the I/O device(s) 314 may be external to the receiver device 300 and may be operatively coupled to the receiver device 300 using a standardized communication protocol, such as for example, Universal Serial Bus (USB) protocol.

The network interface 316 may be configured to enable the receiver device 300 to communicate with external computing devices, such as the receiver device 200 and other devices or servers. Further, in the example where the receiver device 300 includes a smartphone, the network interface 316 may be configured to enable the receiver device 300 to communicate with a cellular network. The network interface 316 may include a network interface card, such as an Ethernet card, an optical transceiver, a radio frequency transceiver, or any other type of device that can send and receive information. The network interface 316 may be configured to operate according to one or more communication protocols such as, for example, a Global System Mobile Communications (GSM) standard, a code division multiple access (CDMA) standard, a 3rd Generation Partnership Project (3GPP) standard, an Internet Protocol (IP) standard, a Wireless Application Protocol (WAP) standard, Bluetooth, ZigBee, and/or an IEEE standard, such as, one or more of the 802.11 standards, as well as various combinations thereof.

As illustrated in FIG. 3, the system memory 304 includes the operating system 306, the HTML browser 309, and the applications 308 stored thereon. The operating system 306 may be configured to facilitate the interaction of applications 308 with the central processing unit(s) 302, and other hardware components of the receiver device 300. The operating system 306 may be an operating system designed to be installed on laptops and desktops. For example, the operating system 306 may be a Windows(a registered trademark) operating system, Linux, or Mac OS. The operating system 306 may be an operating system designed to be installed smartphones, tablets, and/or gaming devices. For example, the operating system 306 may be an Android, iOS, WebOS, Windows Mobile(a registered trademark), or a Windows Phone(a registered trademark) operating system. It should be noted that the techniques described herein are not limited to a particular operating system.

The applications 308 may be any applications implemented within or executed by receiver device 300 and may be implemented or contained within, operable by, executed by, and/or be operatively/communicatively coupled to components of receiver device 300. The applications 308 may include instructions that may cause the central processing unit(s) 302 of the receiver device 300 to perform particular functions. The applications 308 may include algorithms which are expressed in computer programming statements, such as, for loops, while-loops, if-statements, do-loops, etc. Further, the applications 308 may include second screen applications.

Various event tables may provide information about events. These may include tables such as TDO Parameters Table (TPT) of ATSC A/105:2014: “ATSC Candidate Standard: Interactive Services Standard”, April 2014 incorporated by reference herein in its entirety, event message table (EMT), event stream table (EST), etc. These are just examples and any table or data structure that carries event and/or action information may be referred to as event table herein.

Although application tables and event tables are specified separately. In some case they may be combined. Also other type of tables may be define. For example a service list table may provide service level information. In some case a signaling table may be defined. The techniques described in this disclosure are applicable to any such tables which needs to be communicated dynamically from one entity to another entity. Dynamic communication refers to being able to send a new or updated version of table or information therein from one entity to another in real-time.

An action may be taken as a result of delivering an event, which may be initiated by notifications delivered by any mechanism, such as being delivered using a broadcast based system or a broadband based system, whether encoded in a traditional data service or within the bitstream encoded in one or more watermarks.

In a general manner, events may be included within event streams, which have one or more of the following attributes,
schemeIdUri is a globally unique identifier of the type of the event stream;
value is an identifier of the sub-type of the event stream, scoped by schemeIdUri; and
timescale is a time scale used for the timing of events in the event stream.

Each individual event in an event Stream may have one or more of the following additional attributes,
presentationTime is a start time of the event;
duration is a duration of the event;
id is a unique identifier of the event within the eventstream; and
data is data that accompanies the event that is used by an application that responds to the event.

The data types of these attributes and their semantics may be modified, as desired.

The specifier of an event stream may select the “schemeIdUri” attribute and determine the possible values of the “value” attribute and their properties, including whether a “data” element is included, and if so what its structure is.

The delivery of the events in a broadcast based system preferably uses either Real-time Object delivery over Unidirectional Transport/Dynamic Adaptive Streaming over HTTP (ROUTE/DASH) based services or MPEG Media Transport (MMT) based services. ROUTE/DASH and MMT are defined in ATSC A/331 Candidate Standard available at:

http://atsc.org/candidate-standard/a331-atsc-candidate-standard-signaling-delivery-syn chronization-and-error-protection/which is incorporated herein by reference. MMT is described in ISO/IEC:ISO/IEC23008-1, “Information technology-High efficiency coding and media delivery in heterogeneous environments-Part 1:MPEG media transport (MMT),” which is incorporated by reference herein in its entirety. MMT defines a MPU (MMT package Processing Unit) as “a media data item that may be processed by an MMT entity and consumed by the presentation engine independently from other MPUs.” With respect to broadcast events delivered via the ROUTE/DASH-based system, the events may be delivered as DASH events, using either of the two mechanisms for event delivery defined in the DASH specification. The first mechanism is EventStream element(s) appearing in a period element of the MPD(Media Presentation Description). The second mechanism is event(s) in ‘emsg’ box(es) appearing in representation segments, with their presence signaled by one or more InbandEventStream elements of the representation in the MPD. The first and second mechanism may be mixed, if desired, resulting in a single event stream that includes some events delivered via an EventStream element and others delivered via ‘emsg’ boxes.

The EventStream element, defined in section 5.10.2 of the DASH standard ISO/IEC 23009-1:2012 Information technology—Dynamic adaptive streaming over HTTP (DASH)—Part 1: Media presentation description and segment formats, incorporated by reference herein, is especially well suited for “static” events—i.e., events for which the timing is known ahead of time. An EventStream element maybe generally considered a list of event elements. Each EventStream element may have a schemeIdUri attribute and a value attribute to identify the type of events in the EventStream, and a timescale attribute to indicate the reference time scale for the event presentation times and durations. Each event in an EventStream element may have a presentationTime attribute to indicate the start time of the event (relative to the start of the period), a duration attribute to indicate the duration of the event, an id attribute to identify the event instance, and a data element to provide information for carrying out the action initiated by the event. The structure of the data element is determined by the type of the event. There can be multiple EventStream elements of different types in a period.

Some DASH-specific schemeIdUri identifiers are defined in section 5.10.4 of the

DASH standard, along with the usage of the accompanying value identifiers and the semantics of the corresponding events. Additional schemeIdUri identifiers may be defined as desired. The “owner” of a schemeIdUri value may ensure that it is unique (for example, that it is based on a URI controlled by the owner), and may define the usage of the corresponding value attribute and the semantics of the events.

An ATSC-specific schemeIdUri identifier may be defined, along with the usage of the accompanying value identifier and the semantics of the events. Other schemeIdUri identifiers can be defined by application developers, as desired, for particular applications.

An InbandEventStream element of a representation indicates the presence of ‘emsg’ boxes in the segments of the representation. The InbandEvent element may have attributes schemeIdUri and value to indicate the type of the events that can appear. Each ‘emsg’ box that appears in a segment of a representation may have fields schemeIdUri and value to indicate the event stream, they belong to, and fields (a) timescale to indicate the reference time scale for the event, used for the presentation time and the duration, (b) presentation_time_delta to indicate the start time of the event relative to the earliest presentation time of any access unit in the segment in which the ‘emsg’ box appears, (c) event_duration to indicate the duration of the event, (d) id to identify the event instance, and (e) message_data if needed to carry out the action initiated by the event. Events delivered in ‘emsg’ boxes are especially well suited for “dynamic” events—i.e., events for which the timing only becomes known at the last minute (such as an event initiating some action by an application when a touchdown is scored in a football game).

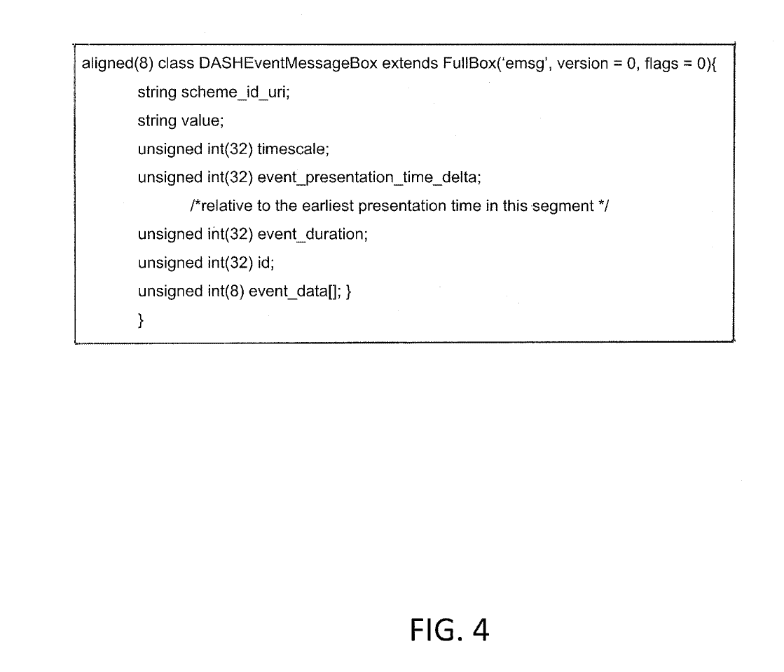

Referring to FIG. 4, the structure of an ‘emsg’ box as defined in the DASH standard is illustrated.

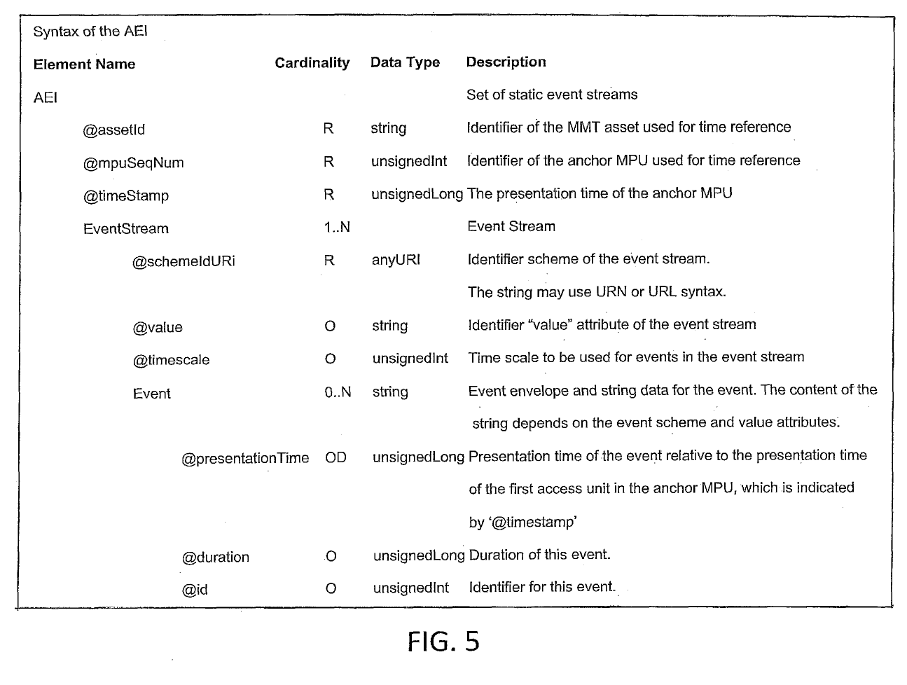

Referring to FIG. 5, with respect to broadcast events delivered via the MMT-based system, the events may be delivered in an XML document referred to as an application event information (AEI) document. This document is suitable for static events. When an AEI is delivered via a broadcast, it may be delivered in the service layer signaling for the service. Events in an MMT-based service may also be carried in ‘evti’ boxes in MPUs. This technique is well suited for dynamic events.

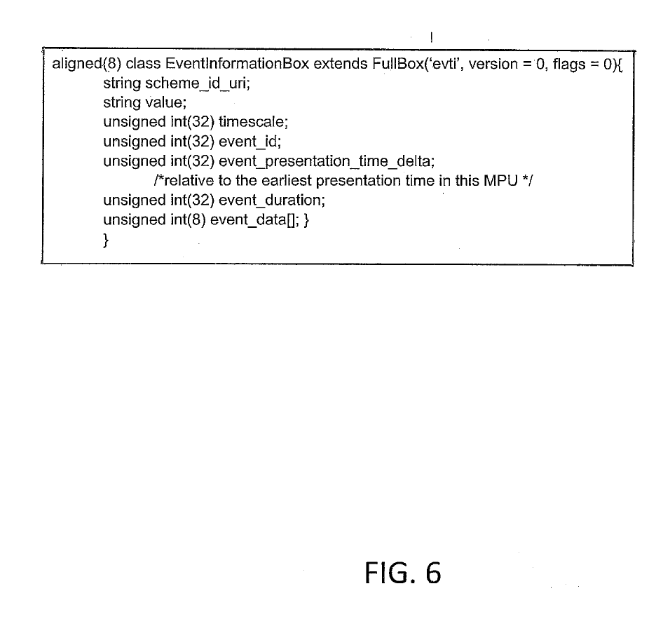

Referring to FIG. 6, an exemplary structure of an ‘evti’ box is illustrated. Such an ‘evti’ box may appear at the beginning of the MPU, after the ‘ftyp’ box, but before the ‘moov’ box, or it may appear immediately before any ‘moo’ box. These boxes—‘ftyp’, ‘moov’, ‘moo’ are as described in ISO/IEC 14496-15:2014: “Information technology—Coding of audio-visual objects—Part 15: Carriage of NAL unit structured video in the ISO base media file format” which is incorporated herein by reference.

The MMT event descriptor may be signed in a MMT Package table (MPT), as defined in ISO/IEC 23008-1, incorporated by reference herein in its entirety.

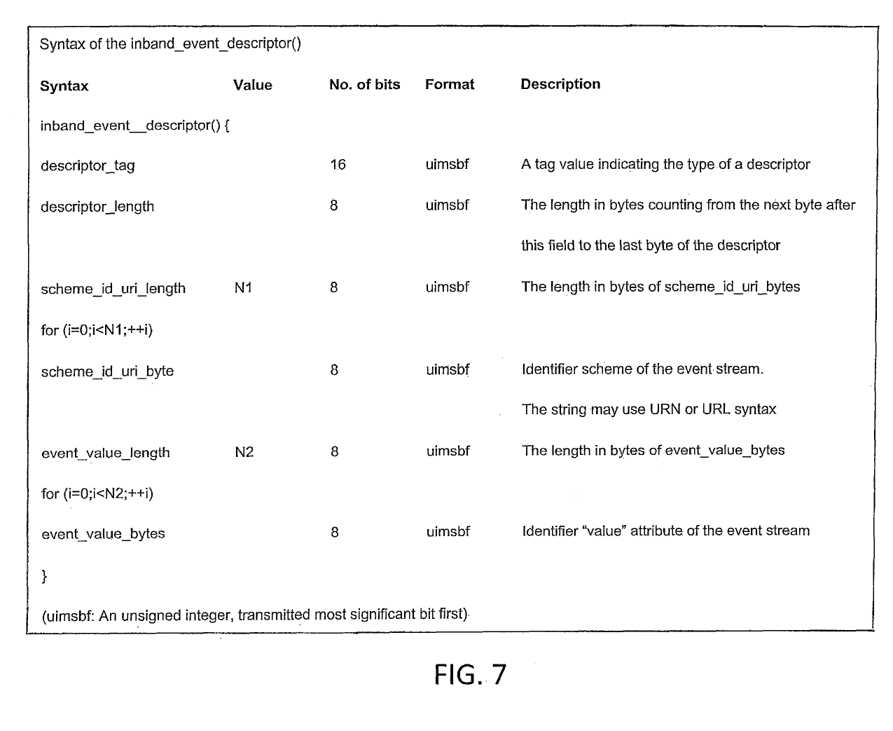

Referring to FIG. 7, the MMT Package Table (MPT) message provides the information related to an MMT Package including the list of assets. An inband_event_descriptor( )contained in an asset-level descriptor part of the signaling message indicates the presence of events in the MPUs.

As described herein, the broadcast delivery supports batch delivery of events in an

MPD or AEI and incremental delivery of events in representation segments or MPUs, the broadband delivery may also support batch delivery and incremental delivery. When events for a service are delivered via broadband in batch mode (which is especially suitable for static events), they may be delivered in EventStream elements in an MPD which is delivered via broadband using HTTP, or in an AEI which is delivered via broadband using HTTP. When delivered via broadband, MPDs and AEIs may be available by an HTTP Request, using the base URL for this purpose which is signaled in the SLT for the service (or a URL obtained from a watermark in a redistribution technique).

The timing and location for retrieving a scheduled update to an MPD or AEI via broadband are provided by the validUntil and nextURL properties in the metadata wrapper of the MPD or AEI. An unscheduled update availability is signaled asynchronously via a dynamic event.

When events for a service are delivered incrementally via broadband (which is especially suitable for dynamic events), they may be delivered as ‘emsg’ boxes in DASH Segments of content being delivered via broadband, if any components of the service are being delivered via broadband, or they may be acquired via polling an HTTP server, using the URL of a dynamic Event server obtained from the SLT, or they may be acquired via a dynamic event websocket server, using the URL of a dynamic event websocket server obtained from the SLT.

The format of events delivered via HTTP servers or web sockets may be the same as the format of the ‘emsg’ boxes described herein for ROUTE/DASH-based services, or the format of the ‘evti’ boxes defined above for MMT-based services, except that in the ROUTE/DASH case they are prefixed with an MPD ID and a Period ID, and in the MMT case they are prefixed with an Asset ID and an MPU sequence number. In the ROUTE/DASH case the presentation_delta is relative to the start time of the referenced period, and in the MMT case the presentation_delta is relative to the earliest access unit presentation time of the referenced MPU.

In a redistribution setting, events can be acquired via watermarks, as described in the A/336 “Audio/Video Watermark Payload” standard incorporated by reference herein. Events can also be delivered in the private data area of audio streams.

It is desirable to include a technique by which events from various source may be registered, such as those events available by a broadband technique and/or a broadcast technique or locally via receiver. While registering to receive particular events may be beneficial, such as all events for an application related to a football game, it may be desirable to include the capability of registering for only particular types of such events, such as an event when touchdowns of a football game happen as opposed to an event when field goals of a football game happen. In the case of selective capability to transmit events to a particular receiver, or selective capability to transmit events from a receiver to an application the selected types of events that are registered, and in particular the selected sub-events that are registered, may be provided from a transmitter to a receiver or from a receiver to an application while omitting providing the other type of events and sub-events. In the case that there is no selective capability to transmit events to a particular receiver, the selected types of events that are registered, and in particular the selected sub-events that are registered, may be filtered to only include the registered events and sub-events by the tuner of the receiver. In some cases, while registering to receive particular events it may be desirable to increase the computational efficiency of the receiving system and increase the likelihood that such events are received, by grouping a plurality of events together in a single data structure that is being provided.

Applications running on for example a receiver, such as in a run-time platform, may be notified when particular events occur. An application that wishes to be notified when a particular type of event occurs may register with the provider of the event for that type of event and may also provide a name of a callback routine.

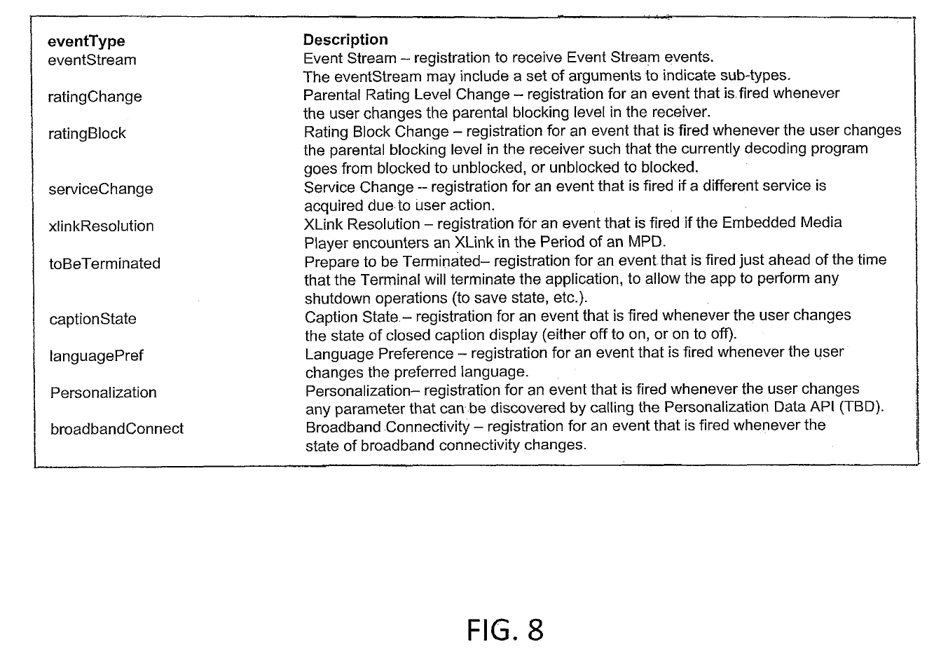

The Event Registration API may be defined as follows:
method: “org.atsc.event.register”
params: Event type (see FIG. 8) which is required and, callback routine name and for some types of events, one or more additional argument object.

An exemplary JSON Schema for event registration API may be defined as follows:

```
{  “type”: “object”,
      “properties”: {
        “eventType”: {
          “type”: “string”
        },
        “callbackFunction”: {
          “type”: “string”
        },
      “eventArg”: (“type”: object”}
      },
      “required”: [
        “eventType”
      ]
}
eventType: This string shall correspond to a value specified in FIG. 8
  eventType column
eventArg: The eventArg object shall be present for certain values of
  eventType and absent otherwise. The required structure of the
  eventArg object for a particular eventType is defined in the
  reference given in FIG. 8. Only events of type eventStream have
  eventArg present.
callBackFunction: call back function
```

In another example an exemplary JSON Schema for event registration API may be defined as follows:

```
        {
  “type”: “object”,
  “properties”: {
      “eventType”: {“type”: “string”},
      “eventArg”: {“type”: “object”},
      “required”: [“eventType”]
  },
      “required”: [“eventType”]
}
    eventType: This string shall correspond to a value specified in FIG. 8
      eventType column
    eventArg: The eventArg object shall be present for certain values of
      eventType and absent otherwise. The required structure of the
      eventArg object for a particular eventType is defined in the
      reference given in FIG. 8. Only events of type eventStream have
      eventArg present.
```

The result from the invocation of the method: org.atsc.event.register may be: regID (String): registration identifier string associated with this registration if registration was successful and null if registration was unsuccessful.

In a further variant a success/error code may also be returned as a result. The resulting error codes may be, as follows, if desired.
E.g. rCode (error code—integer):
200=successful registration
400=registration failed (no such event type)
401=registration failed (no such schemeIdUri)
402=registration failed (no such value)
404=registration failed

To facilitate the capability of the registration of events, where only certain sub-types of events are requested by an application, the JSON Schema for event registration API may be modified. For such stream events the event registration API may be augmented to include schemeIdUri and value properties. This allows an application to request only certain sub-types of events. This results in a more efficient application since it does not need to do the filtering of event sub-types to decide only events of interest and the provider of such events may selectively provide only the desirable events.

A modified JSON Schema may be as follows:

```
    {
      “type”: “object”,
      “properties”: {
        “eventType”: {“type”: “string”},
        “eventArg”: {
          “type”: “object”,
          “properties”: {
            “schemeIdUri”: {
              “type”: “string”,
              “format”: “uri”
            },
            “value”: {“type”: “string”}
          },
          “required”: [“schemeIdUri”]
        }
      },
      “required”: [“eventType”]
}
```

The result from the invocation of the method: org.atsc.event.register may be: regID (String): registration identifier string associated with this registration if registration was successful and null if registration was unsuccessful.

In a further variant a success/error code may also be returned as a result. The resulting error codes may be, as follows, if desired.
E.g. rCode (error code—integer):
200=successful registration
400=registration failed (no such event type)
401=registration failed (no such schemeIdUri)
402=registration failed (no such value)
404=registration failed

The parameters of the modified JSON Schema include a eventArg.schemeIdUri property that identifies the event sub-type, and is preferably a URI. The parameters of the modified JSON Schema include a eventArg.value property that specifies the value for the event identified by the event sub-type eventArg.schemeIdUri.

Inclusion of eventArg.value allows further filtering of events when registering. Thus now the application can register to the receiver only the events which correspond to specified event type supplied by the parameter eventType, then a particular identifier specified by the parameter eventArg.schemeIdUri and further only certain types of values corresponding to this identifier as specified by the parameter eventArg.value. The addition of eventArg.value allows an application not interested in certain type of events which correspond to same eventArg.schemeIdUri but a value different than value of interest to the application as specified by parameter eventArg.value to not be received by the application which reduces burden on the application to process such event which are of no interest to it. This allow writing more targeted and efficient applications.

An example of an application registering for eventStream type event is as shown below:

```
--> {
  ″jsonrpc″: ″2.0″,
  ″method″: ″org.atsc.event.register″,
  ″params″: {
    ″eventType″: ″eventStream″,
    ″eventArg″: {″schemeIdURI″: ″urn:uuid: afxd-ghji:2016″}
  },
  ″id″: 2
}
```

In this example the “eventArg” only includes “schemeIDURI” property.

Another example of an application registering for eventStream type event is as shown below:

```
--> {
  ″jsonrpc″: ″2.0″,
  ″method″: ″org.atsc.event.register″,
  ″params″: {
    ″eventType″: ″eventStream″,
    ″eventArg″: {″schemeIdURI″: ″urn:uuid:afxd-ghji:2016″, {″value″:
    ″1″}
  },
  ″id″: 2
}
```

In the above example and in this document following notation is used:
>data sent to Receiver
<data sent to application

In this example the “eventArg” includes a “schemeIdURl” property and also a “value” property. Thus in this case only events in the event stream corresponding to “schemeIdURl” equal to urn:uuid:afxd-ghji:2016 and further “value” equal to “1” will be passed to the application. For example if the event stream receives an event with schemeIdURl” equal to urn:uuid:afxd-ghji:2016 and further “value” equal to “2” then it will not be passed to the application as the “value” of “2” does not match registered values of “1”.

The JSON Schema also defines an additional constraint, such as when eventType has a “type” equal to “eventStream” the schemeIdUri may (or shall if desired) be present and the value may be present. Otherwise (i.e. when eventType has a “type” other than “eventStream”) the schemeUri and value shall not be present.

The JSON Schema also defines an additional constraint, such as if the schemeIdUri and value properties are not included then all events of eventType shall be notified to the application. If schemeIdUri and value properties are included then only events of eventType equal to eventStreamwith schemeIdUri that matches the included schemeIdUri and value that matches the included value shall be notified to the application.

In another variant, a set of multiple eventTypes and sub-types may be registered using a single call. JSON-RPC is a remote procedure call protocol encoded in JSON. Providing ability to allow registering a set of multiple eventTypes and sub-types using a single call reduces the number of required JSON-RPC calls, as each JSON-RPC call requires communication, over for example a WebSocket. An exemplary JSON Schema illustrated below includes an array to register multiple sub-types with a single call.

```
{
    ″type″: ″array″,
    ″items″: {
      ″type″: ″object″,
      ″properties″: {
        ″eventType″: {″type″: ″string″},
        ″eventArg″:
        {
            ″type″: ″object″,
            ″properties″: {
        ″schemeIdUri″: {
              ″type″: ″string″,
              format″:″uri″
        },
        ″value″: {″type″: ″string″}
          }, ″required″: [″schemeIdUri″]
          }
      },
      ″required″: [″eventType″]
    },
    ″minItems″: 1
  }
```

In another variant, it is desirable to include an extensibility feature for the registration of eventTypes and sub-types. This includes additional flexibility in modification of the registered types available. An exemplary JSON Schema illustrated below includes an extensibility feature.

```
{
  ″$schema″: ″http://json-schema.org/draft-04/schema#″,
  ″id″: ″http://atsc.org/version/3.0/RegisteredTypes #″,
  ″title″: ″Event Registration schema″,
  ″description″: ″Schema for Event Registration″,
  ″@context″: {″RegisteredTypes″: ″http://www.atsc.org/atsc/3.0/
  RegisteredTypes″},
  ″RegisteredTypes″: {
    ″type″: ″array″,
    ″items″: {
      ″type″: ″object″,
      ″properties″: {
        ″eventType″: {″type″: ″string″},
        ″eventArg″:
        {
            ″type″: ″object″,
            ″properties″: {
        ″schemeIdUri″: {
              ″type″: ″string″,
              ″format″: ″uri″
        },
        ″value″: {″type″: ″string″}
          }, ″required″: [″schemeIdUri″]
          }
      },
      ″required″: [″eventType″]
    },
    ″minItems″: 1
  }
}
```

In another variant, it is desirable that instead of making schemeIdUri and value as properties of eventArg object these two properties may be indicated outside the sub-type object. In this manner it may be a requirement that the value property shall not be present when schemeIdUri property is not present. An exemplary JSON Schema illustrated below includes the indication outside the sub-type object.

```
{
  ″type″: ″object″,
  ″properties″: {
    ″eventType″: {″type″: ″string″},
    ″schemeIdUri″: {
      ″type″: ″string″,
      ″format″: ″uri″
    },
    ″value″: {″type″: ″string″}
  },
  ″required″: [″eventType″]
}
```

While preferably the callbackFunction is not included in JSON schema for various security reasons—to avoid potentially malicious code to not be executed by the application, it may be additionally defined in each JSON schema if desired. Also, preferably the response to the JSON Schema is none unless an error occurs.

Referring to FIG. 8, an exemplary event registration table is illustrated. In particular, the eventStream type may include sub-events, while preferably none of the other eventType include sub-events.

While the effective registration for events is beneficial, it is likewise beneficial for the effective revocation of such registrations. In particular, applications which have previously registered for notification of events may revoke a previous registration when they are no longer interested in receiving the event notifications they had previously registered for. By way of example, an application may register to receiver certain types of events and then when it receives notifications for those events for which it had registered, start showing those various notification related to a TV program being broadcast to a user. However, the user may after some time has passed decide that he does not want the various notifications as they are distracting him from his TV viewing experience. The user may then ask the application to disable notifications but otherwise continue running

In this case the application which had previously registered to receive the notifications of events may revoke a previous event registration using a registration revocation API when they are no longer interested in receiving the event notifications for which they had previously registered for. An exemplary event registration revocation API maybe as illustrated below.

```
method: ″org.atsc.event.revokeregister″
params: registration identifier, required.
params JSON Schema:
  {
    ″type″: ″object″,
    ″properties″: {″regID″: {″type″: ″string″}},
      ″required″: [″regID″]
  }
```

regID is a string that corresponds to a registration identifier value (output from a previous successful call to method org.atsc.event.register)

result is a seCode (integer): Success/Error code (value: 200=registration revocation successful, 400: Invalid registration ID, 410: registration unsuccessful (valid registration ID)).

Alternatively as opposed to using a registration identifier as an input parameter for revoking a previous registration, an API which passes back the same input parameters as used for registration to an org.atsc.event.register method may be used for registration revocation. In this alternative the event registration revocation API may be as illustrated below.

```
method:  ″org.atsc.event.revokeregister1″
params:  Event type (see FIG. 8) which is required and, callback
routine name and for some types of events, one or more additional
argument object.params JSON Schema:
  {
    ″type″: ″object″,
    ″properties″: {
      ″eventType″: {type″: ″string″},
      ″eventArg″: {″type″: ″object″},
          },
        ″required″: [″eventType″]
  }
```

eventType string corresponds to a value specified in FIG. 8.

eventArg is an object present for certain values of eventType and absent otherwise. The required structure of the eventArg object for a particular eventType is defined in the reference given in FIG. 8.

result of seCode (integer) is Success/Error code. (value: 200=registration revocation successful, 400: Invalid registration, 410: registration unsuccessful).

The JSON RPC messages may be delivered asynchronously from the receiver to the application whenever a registered event occurs. When the receiver detects that an event of a particular type has occurred, and the currently executing application has registered to be notified about that type of event, the Terminal shall issue a WebSocket message to the application that includes the eventType and the data related to that event (if any). The notification message may be formatted as follows:

```
<-- {
  ″jsonrpc″: ″2.0″,
  ″method″: ″org.atsc.event.notify″,
  ″params″: {
      ″eventType″: ″ParameterA″,
      ″eventData″: {ParameterB}
  },
  ″id″: ParameterC
}
ParameterA shall be a valid eventType string from FIG. 8 eventType
column.
ParameterB shall consist of the data associated with the notification,
if any, included as a JSON object.
The definition of the notification message for each type of events
includes the format of the returned JSON eventData object, if any.
ParameterC shall be an integer, required by JSON RPC to associate
notifications with their corresponding response.
  method:  ″org.atsc.event.notify″
    params: Event type, required, and for some types of events,
    event data:
    params JSON Schema:
        {
          ″type″: ″object″,
          ″properties″: {
            ″eventType″: {″type″: ″string″},
            ″eventData″: {″type″: ″object″}
          },
          ″required″: [″eventType″]
        }
```

Where:
eventType shall be a valid eventType string from FIG. 8; and
eventData shall consist of the data associated with the notification, if any, included as a JSON object. The definition of the notification message for each type of events includes the format of the returned JSON data object. For some events, eventData is omitted.

An event stream notification may be issued by the receiver to the currently executing application if it has registered for the eventStream event type, and if an event stream is encountered in the content of the currently selected service or currently playing content that matches the value of schemeIdURl provided when the application registered for Event Stream events. The stream event notification API may be as shown below.
method: “org.atsc.event.notify”
   eventType: “eventStream”
   EventData: A JSON object conforming to the JSON Schema defined below.

The EventData JSON Object may be specified by the following JSON Schema.

```
{
  ″type″: ″object″,
  ″properties″: {
    ″schemeIdUri″: {
      ″type″: ″string″,
      ″format″: ″uri″
    },
    ″value″: {″type″: ″string″},
    ″timescale″: {
      ″type″: ″integer″,
      ″minimum″: 0,
      ″maximum″: 65535
    },
    ″presentationTime″: {
      ″type″: ″integer″,
      ″minimum″: 0,
      ″maximum″: 4294967295
    },
    ″duration″: {
      ″type″: ″integer″,
      ″minimum″: 0,
      ″maximum″: 4294967295
    },
    ″id″: {
      ″type″: ″integer″,
      ″minimum″: 0,
      ″maximum″: 65535
    },
    ″data″: {″type″: ″string″}
  },
  ″required″: [″schemeIdURI″}
}
```

The stream event object (i.e. eventData schema) included in the stream events notification may be constrained by including a data type of stream event data in a JSON data type of object. This allows each stream event to define its own JSON data type for the data that it needs to pass to the application.

The stream events object included in the stream events notification may be constrained by including a constraint in the stream event data definition to forbid indicating a value of 0 for timescale. As in DASH the value of the presentation time in seconds is the division of the value of this presentationTime and the value of the timescale may forbid value of 0 for timescale.

The stream events object included in the stream events notification may be constrained by including a maximum allowed value for timescale and for id to permit a full 32 bit timescale value.

The stream events object included in the stream events notification may be constrained by including allowing the notification of multiple events. This facilitates using a single JSON-RPC call to pass multiple events and event data. This permits a fewer number of JSON-RPC calls since multiple event notifications may be sent by using one JSON-RPC call. Also, as each JSON-RPC call requires communication over, for example a WebSocket, this increases the system reliability. Also, this may permit atomically sending multiple event data to preserve data integrity.

The stream events object included in the stream events notification may be constrained by including a default value defined for the presentationTime, which allows omitting including this property in the event notification.

An exemplary event notification stream event schema to which EventData conforms may be as shown below.

```
{
  ″$schema″: ″http://json-schema.org/draft-04/schema#″,
  ″id″: ″http://atsc.org/version/3.0/EventData#″,
  ″title″: ″Event Stream schema″,
  ″description″: ″Schema for Event Data Notification″,
  ″@context″: {″EventData ″: ″http://www.atsc.org/atsc/3.0/
  EventDataV1″},
          ″EventData″: {
          ″type″: ″array″,
          ″items″: {
″type″: ″object″,
  ″properties″: {
        ″schemeIdUri″: {
            ″type″: ″string″,
            ″format″: ″uri″
        },
        ″value″: {″type″: ″string″},
        ″timescale″: {
            ″type″: ″integer″,
            ″minimum″: 1,
            ″maximum″: 4294967295
        },
        ″presentationTime″: {
            ″type″: ″integer″,
            ″minimum″: 0,
            ″maximum″: 4294967295,
            ″default″: 0
        },
        ″duration″: {
            ″type″: ″integer″,
            ″minimum″: 0,
            ″maximum″: 4294967295.
        },
        ″id″: {
            ″type″: ″integer″,
            ″minimum″: 0,
            ″maximum″: 4294967295
        }
        ″data″: {″oneOf″: [
          {″type″: ″object″},
          {″type″: ″string″}
          ]}
  },
  ″required″: [″schemeIdURI″]
      },
    ″minItems″: 1
    }
}
```

Another exemplary event notification stream event schema to which EventData conforms may be as shown below. In this schema data type of “object” is used for “data”. Also an array of objects “Event” which consists of properties “presentationTime”, “duration”, “id” and “data” is included.

```
{
  ″$schema″: ″http://json-schema.org/draft-04/schema#″.
  ″id″: ″http://atsc.org/version/3.0/EventData#″,
  ″title″: ″ Event Stream schema″,
  ″description″: ″Schema for event data notification″,
  ″@context″: {″EventData″: ″http://www.atsc.org/atsc/3.0/EventDataV1″},
  ″EventData″: {
    ″type″: ″object″,
    ″properties″: {
      ″schemeIdUri″: {
        ″type″: ″string″,
        ″format″: ″uri″
      },
      ″value″: {″type″: ″string″},
      ″timescale″: {
        ″type″: ″integer″,
        ″minimum″: 1,
        ″maximum″: 4294967295
      },
      ″Events″: {
        ″type″: ″array″,
        ″items″: {
          ″type″: ″object″,
          ″properties″: {
            ″presentationTime″: {
              ″type″: ″integer″,
              ″minimum″: 0,
              ″maximum″: 4294967295,
              ″default″: 0
            },
            ″duration″: {
              ″type″: ″integer″,
              ″minimum″: 0,
              ″maximum″: 4294967295
            },
            ″id″: {
              ″type″: ″integer″,
              ″minimum″: 0,
              ″maximum″: 4294967295
            },
            ″data″: {″type″: ″object″}
          }
          ″required″: [
            ″presentationTime″
          ]
        },
        ″minItems″: 1
      },
      ″required″: [″schemeIdURI″]
    }
  }
}
```

Another exemplary event notification stream event schema to which EventData conforms including a data type of data permitted to be either string or object may be as shown below.

```
{
  ″$schema″: ″http://json-schema.org/draft-04/schema#″,
  ″id″: ″http://atsc.org/version/3.0/xxxxxxxxxxxxxxxxxxx″,
  ″title″: ″Stream Event schema″,
  ″description″: ″xxxxxxxxxxxxxxxxxxxx″,
  ″@context″: {″ EventData ″: ″http://www.atsc.org/atsc/3.0/
  EventDataV1″},
  ″ EventData″: {
    ″type″: ″object″,
    ″properties″: {
      ″schemeIdUri″: {
        ″type″: ″string″,
        ″format″: ″uri″
      },
      ″value″: {″type″: ″string″},
      ″timescale″: {
        ″type″: ″integer″,
        ″minimum″: 1,
        ″maximum″: 4294967295
      },
      ″Events″: {
        ″type″: ″array″,
        ″items″: {
          ″type″: ″object″,
          ″properties″: {
            ″presentationTime″: {
              ″type″: ″integer″,
              ″minimum″: 0,
              ″maximum″: 4294967295,
              ″default″: 0
            },
            ″duration″: {
              ″type″: ″integer″,
              ″minimum″: 0,
              ″maximum″: 4294967295
            },
            ″id″: {
              ″type″: ″integer″,
              ″minimum″: 0,
              ″maximum″: 4294967295
            },
            ″data″: {″oneOf″: [
              {″type″: ″object″},
              {″type″: ″string″}
            ]}
          },
          ″required″: [″presentationTime″]
        },
        ″minItems″: 1
      },
      ″required″: [″schemeIdURI″]
    }
  }
}
```

Another exemplary event notification stream event schema to which EventData conforms including an array of multiple properties inside EventData to be notified using a single call, having the benefit of reducing the number of JSON-RPC calls as each JSON-RPC call requires communication over, for example a WebSocket, may be as shown below.

```
{
  ″$schema″: ″http://json-schema.org/draft-04/schema#″,
  ″id″: ″http://atsc.org/version/3.0/xxxxxxxxxxxxxxxxxxx″,
  ″title″: ″Stream Event schema″,
  ″description″: ″xxxxxxxxxxxxxxxxxxxx″,
  ″@context″: {″ EventData″: ″http://www.atsc.org/contexts/3.0/
  EventDataV1″},
  ″ EventData″: {
    ″type″: ″array″,
    ″items″: {
      ″type″: ″object″,
      ″properties″: {
        ″schemeIdUri″: {
          ″type″: ″string″,
          ″format″: ″uri″
        },
        ″value″: {″type″: ″string″},
        ″timescale″: {
          ″type″: ″integer″,
          ″minimum″: 1,
          ″maximum″: 4294967295
        },
        ″Events″: {
          ″type″: ″array″,
          ″items″: {
            ″type″: ″object″,
            ″properties″: {
              ″presentationTime″: {
                ″type″: ″integer″,
                ″minimum″: 0,
                ″maximum″: 4294967295,
                ″default″: 0
              },
              ″duration″: {
                ″type″: ″integer″,
                ″minimum″: 0,
                ″maximum″: 4294967295
              },
              ″id″: {
                ″type″: ″integer″,
                ″minimum″: 0,
                ″maximum″: 4294967295
              },
              ″data″: {″oneOf″: [
                {″type″: ″object″},
                {″type″: ″string″}
              ]}
            },
            ″required″: [″presentationTime″]
          },
          ″minItems″: 1
        },
        ″required″: [″schemeIdURI″]
      },
      ″minItems″: 1
    }
  }
}
```

In a further variant the transport information regarding the source of the event may be included in the EventData as illustrated below. In this case, an additional property “EventTransport” indicates the type of transport protocol for event as either ROUTEDASH (which indicates the event was signaled via ROUTE/DASH transport) or MMT (which indicates the event was signaled via MMT transport) or UNKNOWN (which indicates the event was signaled via a transport protocol which is not known).

```
″EventTransport″: {
    ″enum″: [
    ″ROUTEDASH″
    ″MMT″,
    ″UNKNOWN″
    ]}
  }
```

In a further variant the transport information regarding the source of the event may be included in an additional property EventTransportPath that indicates the path of the transport protocol for the event as either “broadcast” (which indicates the event was signaled via a broadcast) or “broadband” (which indicates the event was signaled via a broadband network) or “local” ((which indicates the event was signaled via a module on the local network or inside receiver) or “watermark” (which indicates the event was signaled via a audio and/or video watermark) or “UNKNOWN” as illustrated below.

```
″EventTransportPath″: {
      ″enum″: [
      ″broadcast″,
      ″broadband″,
      ″local″,
    ″watermark″,
      ″UNKNOWN″
      ] }
  }
```

Different data types may be used for an element compared to those shown above. For example instead of unsignedByte data type unsignedShort data type may be used. In another example instead of unsigned Byte data type a String data type may be used.

For arrays in JSON schemas instead of “minitems”: 1 alternative embodiments may define different value for minitems. For example in some cases “minitems”: 0 may be defined in JSON schemas described in this document.

Various JSON schema property names may be changed. For example instead of “eventStream” the property may be called “StreamEvents” or “StreamEvent” or “EventData” or “eventData”. Similarly instead of property “eventArg” it may be called “subType” or “sub-type” of “eventSubType”. All such different names are within the scope of this document.

Also upper and lower case names may be used interchangeably in this document for example “eventStream” and “EventStream” may mean the same thing. Also “eventData” and “EventData” may mean the same thing. Also “schemeIDURI”, “schemeIdURI”, “schemeIDUri”, “schemeIdUri” may all mean the same thing.

Some of the properties marked in JSON schema as “required” may instead not be required. In other cases some of the properties not marked in JSON schewma sa “required” may instead be made “required”

Instead of signaling a syntax as an attribute it may be signaled as an element. Instead of signaling a syntax as an element it may be signaled as an attribute. Instead of signaling a syntax as a property it may be signaled as an attribute or as an element.

The bit width of various fields may be changed for example instead of 4 bits for an element or a field in the bitstream syntax 5 bits or 8 bits or 2 bits or 38 bits may be used. The actual values listed here are just examples.

In some embodiments instead of a range of code values from x to y, a range of code values from x+p or x−p to y+d or y−d may be kept reserved. For example instead of range of code values from 2-255 being kept reserved, the range of code values from 3-255 may be kept reserved.

Instead of XML format and XML schema JavaScript Object Notation (JSON) format and JSON schema may be used. Alternatively the proposed syntax elements may be signaled using a Comma Separated Values (CSV), Backus-Naur Form (BNF), Augmented Backus-Naur Form (ABNF), or Extended Backus-Naur Form (EBNF).

Instead of JSON format and JSON schema, XML format and XML schema may be used. Alternatively the proposed syntax elements may be signaled using a Comma Separated Values (CSV), Backus-Naur Form (BNF), Augmented Backus-Naur Form (ABNF), or Extended Backus-Naur Form (EBNF).

Cardinality of an element and/or attribute may be changed. For example For example cardinality may be changed from “1” to “1 . . . N” or cardinality may be changed from “1” to “0 . . . N” or cardinality may be changed from “1” to “0 . . . 1” or cardinality may be changed from “0 . . . 1” to “0 . . . N” or cardinality may be changed from “0 . . . N” to “0 . . . 1”.

An element and/or attribute and/or property may be made required when it is shown above as optional. An element and/or attribute and/or property may be made optional when it is shown above as required.

Some child elements may instead be signaled as parent elements or they may be signaled as child elements of another child elements.

All the above variants are intended to be within the scope of the present invention.

Moreover, each functional block or various features of the base station device and the terminal device (the video decoder and the video encoder) used in each of the afore-mentioned embodiments may be implemented or executed by a circuitry, which is typically an integrated circuit or a plurality of integrated circuits. The circuitry designed to execute the functions described in the present specification may comprise a general-purpose processor, a digital signal processor (DSP), an application specific or general application integrated circuit (ASIC), a field programmable gate array (FPGA), or other programmable logic devices, discrete gates or transistor logic, or a discrete hardware component, or a combination thereof. The general-purpose processor may be a microprocessor, or alternatively, the processor may be a conventional processor, a controller, a microcontroller or a state machine. The general-purpose processor or each circuit described above may be configured by a digital circuit or may be configured by an analogue circuit. Further, when a technology of making into an integrated circuit superseding integrated circuits at the present time appears due to advancement of a semi-conductor technology, the integrated circuit by this technology is also able to be used.

It is to be understood that the claims are not limited to the precise configuration and components illustrated above. Various modifications, changes and variations may be made in the arrangement, operation and details of the systems, methods, and apparatus described herein without departing from the scope of the claims.

1. A first device making a request for stream events, the said request comprising registration data to a second device comprising:
(a) said request comprising registration data including a plurality of registration fields for a plurality of respective stream events, where at least one of said registration fields is for a particular sub-type of a respective said stream event;
(b) said request comprising registration fields that include a schemeIdUri and a value, where said schemeIdUri is a URI string associated with a respective said stream event, where said value is a string that identifies a particular sub-type of said stream events identified by said schemeIdUri.

2. The first device of claim 1 wherein said schemeIdUri has a data type of said string and a format of said URI.

3. The first device of claim 1 wherein said value has a data type of string.

4. The first device of claim 1 wherein said registration data is included in a JSON Schema.

5. The first device of claim 1 further comprising at least one of said registration fields is for a particular sub-type of a respective said stream event and
(a) said first device receiving said event data including at least one of:
(i) said first device receiving said event data fields that include an id, where said id is an integer that has a minimum value of 0 and a maximum value of 4294967295;
(ii) said first device receiving said event data fields that include a data, where said data is selected to be one of a data type of object and a data type of string.

6. (canceled)

7. The first device of claim 5 wherein said event data fields include said id, where said id is an integer that has a minimum value of 0 and a maximum value of 4294967295.

8. The first device of claim 5 wherein said event data fields include said data, where said data is selected to be one of a data type of object and a data type of string.

9. A method for a first device in response to making a request comprising registration data for stream events to a second device comprising:
(a) requesting said registration data by said first device including a plurality of registration fields for a plurality of respective stream events, where at least one of said registration fields is for a particular sub-type of a respective said stream event;
(b) requesting said registration fields by said first device that include a schemeIdUri and a value, where said schemeIdUri is a URI string associated with a respective said stream event, where said value is a string that identifies a particular sub-type of said stream events identified by said schemeIdUri.

10-16. (canceled)

17. A second device in response to receiving a request including registration data from a first device for providing event data for stream events comprising:
(a) said second device receiving said registration data including a plurality of registration fields for a plurality of respective stream events, where at least one of said registration fields is for a particular sub-type of a respective said stream event;
(b) said second device receiving said registration fields that include a schemeIdUri and a value, where said schemeIdUri is a URI string associated with a respective said stream event, where said value is a string that identifies a particular sub-type of said stream events identified by said schemeIdUri.

18-48. (canceled)
